(19) United States
(12) Patent Application Publication
(10) Pub. No.: US 2017/0155145 A1
(43) Pub. Date: Jun. 1, 2017

(54) NONAQUEOUS ELECTROLYTE SECONDARY BATTERIES

(71) Applicant: Sanyo Electric Co., Ltd., Daito-shi, Osaka (JP)

(72) Inventors: Miki Kusachi, Hyogo (JP); Sho Tsuruta, Hyogo (JP); Takeshi Ogasawara, Hyogo (JP)

(73) Assignee: Sanyo Electric Co., Ltd., Daito-shi, Osaka (JP)

(21) Appl. No.: 15/322,594

(22) PCT Filed: Sep. 7, 2015
(86) PCT No.: PCT/JP2015/004517

§ 371 Date: Dec. 28, 2016

(30) Foreign Application Priority Data
Sep. 25, 2014 (JP) 2014-195443

(51) Int. Cl. H01M 4/525; H01M 4/505; H01M 10/0569; H01M 10/0525

(52) U.S. Cl. CPC H01M 4/525; H01M 10/0525; H01M 4/505; H01M 10/0569; H01M 2004/028

(57) ABSTRACT

A nonaqueous electrolyte secondary battery that releases a reduced amount of gas when stored in a highly charged state at high temperatures, including a positive electrode containing a positive electrode active material capable of storing and releasing lithium ions, a negative electrode containing a negative electrode active material capable of storing and releasing lithium ions, and a nonaqueous electrolyte, wherein the positive electrode active material includes secondary particles formed by the aggregation of primary particles including a lithium transition metal oxide containing lithium, cobalt, nickel, manganese and aluminum, the secondary particles have on the surface thereof a recess formed between the primary particles adjacent to one another and a compound containing boron and oxygen is attached to the recess, and the proportion of cobalt in the lithium transition metal oxide is not less than 80 mol % relative to the total molar amount of the metal elements except lithium.

### TECHNICAL FIELD

The present invention relates to nonaqueous electrolyte secondary batteries.

### BACKGROUND ART

In recent years, nonaqueous electrolyte secondary batteries are demanded to have higher capacity so that they can be used for an extended time, and are also demanded to be enhanced in output characteristics when the batteries are charged and discharged with a large current repeatedly in a relatively short period of time. Some approaches to increasing the capacity of nonaqueous electrolyte secondary batteries are to use a positive electrode active material having a high ratio of Ni, and to increase the charging voltage.

Patent Literature 1 discloses that a rare earth compound is attached to the surface of a positive electrode active material and that lithium borate is added to a positive electrode mixture layer. According to the disclosure, this configuration prevents the decomposition of fluorinated nonaqueous solvents or fluorinated lithium salts even when the capacity is increased by increasing the charge cutoff voltage, resulting in improvements in high-temperature storage characteristics and high-temperature cycle characteristics.

### CITATION LIST

### Patent Literature

PTL 1: International Publication No. WO 2014/050115

### SUMMARY OF INVENTION

### Technical Problem

It has been found, however, that even the technique disclosed in Patent Literature 1 cannot prevent the generation of gas when the batteries charged to a high voltage are stored at high temperatures.

### Solution to Problem

An aspect of the present invention resides in a nonaqueous electrolyte secondary battery including a positive electrode containing a positive electrode active material capable of storing and releasing lithium ions, a negative electrode containing a negative electrode active material capable of storing and releasing lithium ions, and a nonaqueous electrolyte, wherein the positive electrode active material includes secondary particles formed by the aggregation of primary particles including a lithium transition metal oxide containing lithium, cobalt, nickel, manganese and aluminum, the secondary particles have on the surface thereof a recess formed between the primary particles adjacent to one another and a compound containing boron and oxygen is attached to the recess, and the proportion of cobalt in the lithium transition metal oxide is not less than 80 mol % relative to the total molar amount of the metal elements except lithium.

### Advantageous Effects of Invention

The nonaqueous electrolyte secondary batteries provided in one aspect of the present invention release a reduced amount of gas when the batteries charged to a high voltage are stored at high temperatures.

### BRIEF DESCRIPTION OF DRAWINGS

FIG. 1 is a schematic plan view of a nonaqueous electrolyte secondary battery representing an example of embodiments of the present invention.

FIG. 2 is a schematic sectional view taken along line II-II in FIG. 1.

### DESCRIPTION OF EMBODIMENTS

Embodiments of the present invention will be described hereinbelow. The embodiments below are only illustrative of the invention, and the scope of the invention is not limited to such embodiments.

### [Nonaqueous Electrolyte Secondary Batteries]

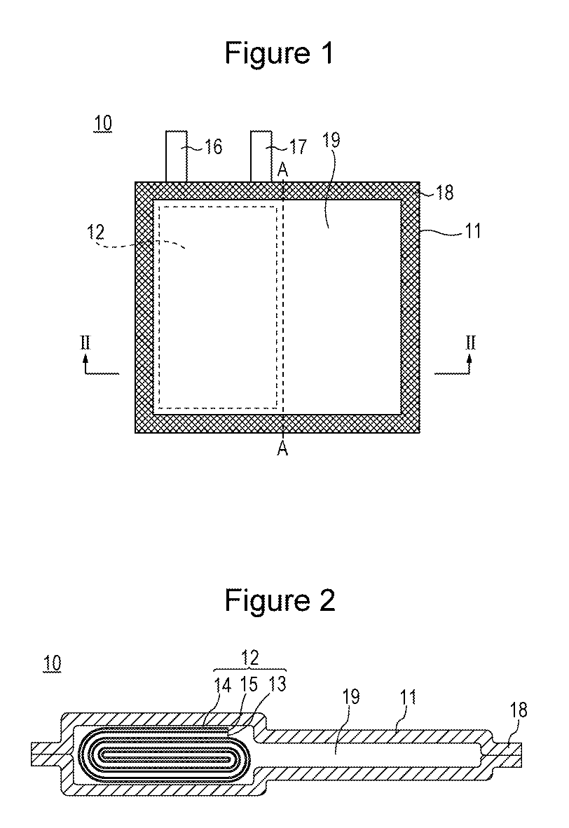

For example, a nonaqueous electrolyte secondary battery according to an embodiment of the present invention may have a structure in which an electrode assembly that includes a positive electrode and a negative electrode wound together via a separator, and a nonaqueous electrolyte are accommodated in an exterior case. Specific configurations of such nonaqueous electrolyte secondary batteries will be described in detail with reference to FIGS. 1 and 2.

As illustrated in FIGS. 1 and 2, a nonaqueous electrolyte secondary battery 10 includes a laminate exterior case 11 as an outer covering, a flat wound electrode assembly 12, and a nonaqueous electrolytic solution as a nonaqueous electrolyte. The wound electrode assembly 12 has a positive electrode 13 and a negative electrode 14 that are wound into a flat coil while being insulated from each other via a separator 15. A positive electrode current collector tab 16 is connected to the positive electrode 13 in the wound electrode assembly 12. Similarly, a negative electrode current collector tab 17 is connected to the negative electrode 14. The wound electrode assembly 12 is enclosed in the laminate exterior case 11 as an outer covering together with the nonaqueous electrolytic solution. The outer peripheral edge portion of the laminate exterior case 11 is sealed to define a heat-sealed portion 18.

In the figures, an extended space 19 is a backup space for minimizing the influence on charging and discharging that will be caused by a gas generated by the decomposition of the components such as the electrolytic solution during preliminary charging of the battery. After preliminary charging, the laminate exterior case 11 is tightly closed by being heat sealed along line A-A and thereafter the extended space 19 is cut off.

The structure of the electrode assembly, and the exterior case are not limited to those described above. For example, the structure of the electrode assembly may be a stack type in which positive electrodes and negative electrodes are stacked alternately via separators. The exterior case may be, for example, a metallic battery case having a prismatic shape or the like.

### [Positive Electrodes]

The positive electrode is preferably composed of a positive electrode current collector and a positive electrode mixture layer disposed on the positive electrode current collector. Examples of the positive electrode current collectors include conductive thin films, in particular, foils of metals and alloys that are stable at positive electrode potentials such as aluminum, and films having a skin layer of a metal such as aluminum. The positive electrode mixture layer includes particles of a positive electrode active material, and preferably further includes a binder and a conductive agent.

The positive electrode active material includes secondary particles formed by the aggregation of primary particles including a lithium transition metal oxide containing lithium, cobalt, nickel, manganese and aluminum. The secondary particles have recesses on the surface thereof that are formed between the primary particles adjacent to one another, and a compound containing boron and oxygen is attached to the recesses. The proportion of cobalt in the lithium transition metal oxide is not less than 80 mol % relative to the total molar amount of the metal elements except lithium.

Hereinbelow, the configurations of the positive electrode active material will be described in detail. In the positive electrode active material, primary particles of a lithium transition metal oxide are aggregated to form secondary particles of the lithium transition metal oxide. On the surface of the secondary particles of the lithium transition metal oxide, the primary particles of the lithium transition metal oxide which are adjacent to one another define recesses therebetween, to which a compound containing boron and oxygen is attached.

In the above configuration, a compound containing boron and oxygen adheres to the recesses on the secondary particles of the lithium transition metal oxide. Even when, at a high temperature, the electrolytic solution decreases its viscosity, this compound limits the entry of the electrolytic solution through the interfaces between the primary particles of the lithium transition metal oxide, and thus prevents the occurrence of a reaction that produces gas. As a result, the battery, even when charged to a high voltage, can be stored at high temperatures while attaining a reduction in the generation of gas.

Preferably, the compound containing boron and oxygen is attached to the interfaces between the primary particles that are found in the recesses. When the compound containing boron and oxygen is attached to the interfaces between the primary particles found in the recesses, the electrolytic solution that has decreased its viscosity upon an increase in temperature has a lower chance of entry into the inside through the interfaces between the primary particles of the lithium transition metal oxide. To reduce the probability that the electrolytic solution may find its way into the inside through the interfaces between the primary particles of the lithium transition metal oxide, it is more preferable that the compound containing boron and oxygen be attached not only to the interfaces between the primary particles in the recesses, but also to regions in the recesses other than the interfaces between the primary particles.

The compound containing boron and oxygen is preferably a compound containing lithium, boron and oxygen. When the compound attached to the recesses contains lithium, boron and oxygen, the reaction by which the electrolytic solution is decomposed is selectively a film-forming reaction rather than a gas-producing reaction. As a result, the battery, even when charged to a high voltage, can be stored at high temperatures while attaining a further reduction in the generation of gas.

The lithium transition metal oxide contains lithium, cobalt, nickel, manganese and aluminum, and the proportion of cobalt in the lithium transition metal oxide is not less than 80 mol % relative to the total molar amount of the metal elements except lithium. The crystal structure of such a lithium transition metal oxide is stable. Even when, for example, the battery is charged to 4.53 V or above versus lithium, the crystal structure of the lithium transition metal oxide is unlikely to undergo a phase transition. Consequently, the surface of the lithium transition metal oxide remains low in reactivity with the electrolytic solution, and thus the generation of gas is small.

The lithium transition metal oxide is preferably represented by the compositional formula LiCoₐNi_{b}Mn_{c}Al_{d}MₑO₂ (0.8≦a≦0.95, 0.03≦b≦0.25, 0.02≦c≦0.07, 0.005≦d≦0.02, 0≦e≦0.02, and M is at least one selected from Si, Ti, Ga, Ge, Ru, Pb and Sn). More preferably, 0.8≦a≦0.92, 0.04≦b≦0.20, 0.03≦c≦0.06, 0.005≦d≦0.02, 0≦e≦0.02, and a+b+c+d=1. The lithium metal oxide represented by the above compositional formula has a particularly stable crystal structure. In this case, the crystal structure of the positive electrode active material will not undergo a phase transition even when, for example, the battery is charged to 4.53 V or above versus lithium, and thus the generation of gas is small.

The lithium transition metal oxide may further contain additional elements other than those described above. Examples of the additional elements include boron (B), magnesium (Mg), titanium (Ti), chromium (Cr), iron (Fe), copper (Cu), zinc (Zn), niobium (Nb), molybdenum (Mo), tantalum (Ta), zirconium (Zr), tin (Sn), tungsten (W), sodium (Na), potassium (K), barium (Ba), strontium (Sr) and calcium (Ca).

The lithium transition metal oxide is preferably in the form of secondary particles having an average particle size of 2 to 30 μm which are formed by bonding of primary particles having sizes of 100 nm to 10 μm.

In the positive electrode active material particles, the compound containing boron and oxygen may be attached also to the surface of the secondary particles of the lithium transition metal oxide other than the recesses. When the compound attached to the surface of the secondary particles of the lithium transition metal oxide other than the recesses is one containing lithium, boron and oxygen, the reaction that occurs selectively is a film-forming reaction which gives a film having excellent lithium ion conductivity, and any gas-producing reaction is suppressed more effectively. As a result, the battery, even when charged to a high voltage, can be stored at high temperatures while attaining a further reduction in the generation of gas.

The ratio of the compound containing boron and oxygen to the total mass of the lithium transition metal oxide, as expressed in terms of boron element, is preferably not less than 0.005 mass % and not more than 0.5 mass %, and more preferably not less than 0.05 mass % and not more than 0.3 mass %. If the ratio is below 0.005 mass %, the attachment of the compound containing boron and oxygen to the recesses may fail to attain sufficient effects. If, on the other hand, the ratio is above 0.5 mass %, the relative proportion of the positive electrode active material is correspondingly decreased and consequently the positive electrode capacity is reduced. Here, the ratio of the compound containing boron and oxygen to the total mass of the lithium transition metal oxide is the ratio of the total mass of boron present in the compound containing boron and oxygen that is attached to the recesses between the primary particles of the lithium transition metal oxide which are adjacent to one another on the surface of the secondary particles of the lithium transition metal oxide plus boron in the compound containing boron and oxygen that is attached to regions other than the recesses, relative to the mass of the lithium transition metal oxide.

In an example process for causing the compound containing boron and oxygen to adhere to recesses on the secondary particles of the lithium transition metal oxide, a solution of the compound such as lithium metaborate dihydrate (BLiO₂.2H₂O), boron oxide (B₂O₃) or lithium tetraborate (Li₂B₄O₇) in water or a solvent is sprayed or dropped to the lithium transition metal oxide while performing stirring of the oxide (wet process). The wet process is preferably followed by heat treatment at 200 to 400° C. When heat treatment is performed at 200 to 400° C. after the compound such as boron oxide (B₂O₃) is attached to the recesses on the secondary particles of the lithium transition metal oxide, the compound containing boron and oxygen reacts with lithium present in the vicinity of the surface of the lithium transition metal oxide and consequently the compound attached to the recesses on the secondary particles of the lithium transition metal oxide comes to contain lithium, boron and oxygen.

The positive electrode active material is not limited to the above positive electrode active material particles alone in which the compound containing boron and oxygen is attached to the recesses on the secondary particles of the lithium transition metal oxide, and may include such positive electrode active material particles in combination with other positive electrode active material.

Examples of the binders include fluoropolymers and rubbery polymers. Specific examples include such fluoropolymers as polytetrafluoroethylene (PTFE), polyvinylidene fluoride (PVdF) and modified products thereof, and such rubbery polymers as ethylene-propylene-isoprene copolymer and ethylene-propylene-butadiene copolymer. These may be used singly, or two or more may be used in combination. The binder may be used in combination with a thickener such as carboxymethylcellulose (CMC) or polyethylene oxide (PEO). Examples of the conductive agents include carbon materials such as carbon black, acetylene black, Ketjen black and graphite. These may be used singly, or two or more may be used in combination.

### [Negative Electrodes]

The negative electrode may be conventional. For example, the negative electrode may be obtained by mixing a negative electrode active material and a binder in water or an appropriate solvent, and applying the mixture to a negative electrode current collector followed by drying and rolling. The negative electrode current collector is suitably a conductive thin film, in particular, a foil of a metal or an alloy that is stable at negative electrode potentials such as copper, or a film having a skin layer of a metal such as copper. The binder may be one similar to that used in the positive electrode, such as PTFE, or is preferably, among others, styrene-butadiene copolymer (SBR) or a modified product thereof. The binder may be used in combination with a thickener such as CMC.

The negative electrode active material is not particularly limited as long as it can reversibly store and release lithium ions. Examples include carbon materials, metal or alloy materials which can be alloyed with lithium such as Si and Sn, and metal oxides. These may be used singly, or two or more may be used as a mixture. The material may be a combination of negative electrode active materials selected from carbon materials, metal or alloy materials which can be alloyed with lithium, and metal oxides.

### [Nonaqueous Electrolytes]

Examples of the solvents in the nonaqueous electrolytes include cyclic carbonates such as ethylene carbonate, propylene carbonate, butylene carbonate and vinylene carbonate, fluorinated cyclic carbonates, chain carbonates such as dimethyl carbonate, methyl ethyl carbonate and diethyl carbonate, fluorinated chain carbonates, chain carboxylate esters, and fluorinated chain carboxylate esters. In particular, a mixed solvent including a cyclic carbonate and a chain carbonate or a chain carboxylate ester is a preferred nonaqueous solvent in view of its high dielectric constant, low viscosity and low melting point and also high lithium ion conductivity. In this mixed solvent, the volume ratio of the cyclic carbonate to the chain carbonate or the chain carboxylate ester is preferably controlled to the range of 2:8 to 5:5.

Fluorinated solvents such as fluorinated cyclic carbonates, fluorinated chain carbonates and fluorinated chain carboxylate esters have high oxidation decomposition potential and are highly resistant to oxidation. Thus, such solvents are advantageously resistant to decomposition during the storage of the batteries charged to a high voltage. Examples of the fluorinated cyclic carbonates include 4-fluoroethylene carbonate (4-FEC), 4,5-difluoroethylene carbonate, 4,4-difluoroethylene carbonate, 4,4,5-trifluoroethylene carbonate and 4,4,5,5-tetrafluoroethylene carbonate. Of these, 4-fluoroethylene carbonate is particularly preferable. Examples of the fluorinated chain carbonates include methyl 2,2,2-trifluoroethyl carbonate (F-EMC). Examples of the fluorinated chain carboxylate esters include methyl 3,3,3-trifluoropropionate (FMP). It is preferable that the fluorinated solvent represent 5 to 90 vol % of the total volume of the nonaqueous solvents.

Further, the above solvents may be used together with, among others, ester-containing compounds such as methyl acetate, ethyl acetate, propyl acetate, methyl propionate, ethyl propionate and γ-butyrolactone; sulfone group-containing compounds such as propanesultone; ether-containing compounds such as 1,2-dimethoxyethane, 1,2-diethoxyethane, tetrahydrofuran, 1,3-dioxane, 1,4-dioxane and 2-methyltetrahydrofuran; nitrile-containing compounds such as butyronitrile, valeronitrile, n-heptanenitrile, succinonitrile, glutaronitrile, adiponitrile, pimelonitrile, 1,2,3-propanetricarbonitrile, 1,3,5-pentanetricarbonitrile and hexamethylene diisocyanate; and amide-containing compounds such as dimethylformamide. These solvents may be substituted with fluorine atoms F in place of part of the hydrogen atoms H. In particular, 1,3-propanesultone and hexamethylene diisocyanate are preferable in that they form a quality film on the surface of the positive electrode or the surface of the negative electrode.

Examples of the solutes in the nonaqueous electrolytes include fluorine-containing lithium salts such as LiPF₆, LiBF₄, LiCF₃SO₃, LiN(FSO₂)₂, LiN(CF₃SO₂)₂, LiN(C₂F₅SO₂)₂, LiN(CF₃SO₂)(C₄F₉SO₂), LiC(C₂F₅SO₂)₃ and LiAsF₆. Further, a lithium salt other than fluorine-containing lithium salts [a lithium salt containing one or more elements of P, B, O, S, N and Cl (such as, for example, LiClO₄)] may be added to the fluorine-containing lithium salt. In particular, it is preferable that the solute include a fluorine-containing lithium salt and a lithium salt having an oxalato complex as the anion because such a solute forms a film on the negative electrode surface that is stable even under high-temperature conditions.

Examples of the lithium salts having an oxalato complex as the anion include LiBOB [lithium-bisoxalatoborate], Li[B(C₂O₄)F₂], Li[P(C₂O₄)F₄] and Li[P(C₂O₄)₂F₂]. In particular, it is preferable to use LiBOB, which can form a stable film on the negative electrode. The solutes may be used singly, or two or more may be used in combination.

### [Separators]

Examples of the separators include polypropylene or polyethylene separators, polypropylene-polyethylene multilayer separators, and separators coated with resins such as aramid resins.

An inorganic filler layer may be formed in the interface between the positive electrode and the separator, or in the interface between the negative electrode and the separator. Examples of the fillers include oxides and phosphate compounds containing one or more of elements such as titanium, aluminum, silicon and magnesium, and such oxides and phosphate compounds which are surface-treated with agents such as hydroxide. For example, the filler layer may be formed by directly applying a filler-containing slurry onto the positive electrode, the negative electrode or the separator, or by applying a separately formed sheet of the filler to the positive electrode, the negative electrode or the separator.

### EXAMPLES

Hereinbelow, embodiments for carrying out the present invention will be described in greater detail based on experimental examples. The experimental examples presented below only illustrate some examples of the positive electrodes for nonaqueous electrolyte secondary batteries, the nonaqueous electrolyte secondary batteries, and the positive electrode active materials for nonaqueous electrolyte secondary batteries to give a concrete form to the technical idea of the present invention, and thus do not intend to limit the scope of the invention to any of such experimental examples. The present invention may be carried out while adding appropriate modifications to these experimental examples without departing from the scope of the invention.

### First Experimental Examples

### Experimental Example 1

### [Preparation of Positive Electrode Active Material]

Cobalt tetraoxide (Co₃O₄) 67.4 g, nickel hydroxide (Ni(OH)₂) 9.27 g, manganese dioxide (MnO₂) 4.35 g and aluminum hydroxide (Al(OH)₃) 0.78 g were dry mixed. The mixture was further mixed together with lithium carbonate (Li₂CO₃) 36.9 g. The resultant mixture powder was compacted into pellets, which were then calcined in the air atmosphere at 980° C. for 24 hours. Thus, a lithium transition metal oxide represented by LiCo_{0.84}Ni_{0.10}Mn_{0.05}Al_{0.01}O₂ was obtained.

While performing stirring of 500 g of the lithium transition metal oxide obtained above, an aqueous solution was added which contained 0.18 mass % of boron oxide (B₂O₃) relative to the transition metal elements in the lithium transition metal oxide in 50 mL of water (wet mixing). The resultant powder was dried at 120° C. and was heat treated at 300° C. A positive electrode active material was thus prepared.

### [Fabrication of Positive Electrode]

The positive electrode active material prepared above, acetylene black and polyvinylidene fluoride powder were mixed together in a mass ratio of 96.5:1.5:2.0. The mixture was mixed together with an N-methylpyrrolidone solution to give a positive electrode mixture slurry. Next, the positive electrode mixture slurry was applied to both sides of a 15 m thick positive electrode core made of aluminum, thus forming a positive electrode mixture layer on both sides of the positive electrode current collector. The layers were then dried, rolled with a roller, and cut to a prescribed size. A positive electrode plate was thus fabricated. An aluminum tab was attached to a portion of the positive electrode plate which was exposed from the positive electrode mixture layer, and a positive electrode was thus produced. The amount of the positive electrode mixture layers was 376 mg/cm², and the thickness of the positive electrode mixture layer was 120 μm.

A cross section for observation of the positive electrode plate was prepared by a cross section polisher (CP) method. The cross section was then analyzed on a wavelength dispersive X-ray spectrometer (WDX) to observe the secondary particles of the lithium transition metal oxide present in the electrode plate. The observation showed the presence of boron element at interfaces of adjacent primary particles on the surface of the secondary particles of the lithium transition metal oxide. The observation also showed that primary particles which were adjacent to one another had formed recesses on the surface of the secondary particles of the lithium transition metal oxide, and that the compound containing boron had been attached to at least portions of the interfaces between the primary particles in the recesses and also to surfaces of the primary particles in the recesses other than the interfaces.

### [Fabrication of Negative Electrode]

Graphite, carboxymethylcellulose and styrene butadiene rubber were weighed in a mass ratio of 98:1:1 and were dispersed into water to give a negative electrode mixture slurry. The negative electrode mixture slurry was applied to both sides of an 8 μm thick negative electrode core made of copper. The layers were then dried, rolled with a roller, and cut to a prescribed size. A negative electrode plate was thus fabricated. A nickel tab was attached to a portion of the negative electrode plate which was exposed from the negative electrode mixture layer, and a negative electrode was thus produced. The amount of the negative electrode mixture layers was 226 mg/cm^{z}, and the thickness of the negative electrode mixture layer was 141 μm.

### [Preparation of Nonaqueous Electrolytic Solution]

As nonaqueous solvents, 4-fluoroethylene carbonate (4-FEC) and methyl 3,3,3-trifluoropropionate (FMP) were mixed together so that the volume ratio FEC:FMP at 25° C. would be 20:80. To this nonaqueous solvent, lithium hexafluorophosphate (LiPF₆) was dissolved with a concentration of 1 mol/L. A nonaqueous electrolyte was thus prepared.

### [Fabrication of Nonaqueous Electrolyte Secondary Battery]

The positive electrode and the negative electrode obtained above were wound into a coil via a microporous polyethylene film as a separator between the electrodes. The winding core was pulled out, and a wound electrode assembly was obtained. Next, the wound electrode assembly was pressed into a flat electrode assembly. Thereafter, the flat electrode assembly and the nonaqueous electrolytic solution were inserted into an exterior case made of an aluminum laminate. A battery A1 was thus fabricated. The size of the battery was 3.6 mm in thickness, 35 mm in width and 62 mm in length. The discharge capacity of the nonaqueous electrolyte secondary battery when charged to a voltage of 4.5 V versus lithium was 800 mAh.

### Experimental Example 2

A nonaqueous electrolyte secondary battery A2 was fabricated in the same manner as in EXPERIMENTAL EXAMPLE 1, except that boron oxide (B₂O₃) was replaced by lithium metaborate dihydrate (BLiO₂.2H₂O). The positive electrode plate obtained using such a positive electrode active material was cut by a cross section polisher (CP) method to expose a cross section for observation. The cross section was then analyzed on a wavelength dispersive X-ray spectrometer (WDX) to observe the secondary particles of the lithium transition metal oxide present in the electrode plate. The observation showed the presence of boron element at interfaces of adjacent primary particles on the surface of the secondary particles of the lithium transition metal oxide. The observation also showed that primary particles which were adjacent to one another had formed recesses on the surface of the secondary particles of the lithium transition metal oxide, and that the compound containing boron had been attached to at least portions of the interfaces between the primary particles in the recesses and also to surfaces of the primary particles in the recesses other than the interfaces.

### Experimental Example 3

A nonaqueous electrolyte secondary battery A3 was fabricated in the same manner as in EXPERIMENTAL EXAMPLE 1, except that the lithium transition metal oxide represented by LiCo_{0.84}Ni_{0.10}Mn_{0.05}Al_{0.01}O₂ was used as the positive electrode active material without attaching any compound containing boron and lithium to the positive electrode active material.

### Experimental Example 4

A nonaqueous electrolyte secondary battery A4 was fabricated in the same manner as in EXPERIMENTAL EXAMPLE 3, except that in the fabrication of the positive electrode, 0.5 mass % of boron oxide (B₂O₃) relative to LiCo_{0.84}Ni_{0.10}Mn_{0.05}Al_{0.01}O₂ was added to the positive electrode mixture slurry.

### Experimental Example 5

A nonaqueous electrolyte secondary battery A5 was fabricated in the same manner as in EXPERIMENTAL EXAMPLE 1, except that the positive electrode active material was prepared by dry mixing the lithium transition metal oxide with 0.5 mass % of boron oxide (B₂O₃) relative to the transition metal elements in the lithium transition metal oxide using NOBILTA (manufactured by HOSOKAWA MICRON CORPORATION), and heat treating the mixture at 800° C. A cross section for observation of the positive electrode plate was prepared by a cross section polisher (CP) method. The cross section was then analyzed on a wavelength dispersive X-ray spectrometer (WDX) to observe the secondary particles of the lithium transition metal oxide present in the electrode plate. The observation showed that boron element had been attached to the surface of the secondary particles of the lithium transition metal oxide. Further, the compound containing boron was found to have been attached in a dispersive manner over the surface of the secondary particles of the lithium transition metal oxide.

### Experimental Example 6

A nonaqueous electrolyte secondary battery A6 was fabricated in the same manner as in EXPERIMENTAL EXAMPLE 1, except that lithium cobaltate (LiCoO₂) was used as the lithium transition metal oxide. A cross section for observation of the positive electrode plate was prepared by a cross section polisher (CP) method. The cross section was then analyzed on a wavelength dispersive X-ray spectrometer (WDX) to observe the secondary particles of the lithium transition metal oxide present in the electrode plate. The observation showed the presence of boron element at interfaces of adjacent primary particles on the surface of the secondary particles of the lithium transition metal oxide. The observation also showed that primary particles which were adjacent to one another had formed recesses on the surface of the secondary particles of the lithium transition metal oxide, and that the compound containing boron had been attached to at least portions of the interfaces between the primary particles in the recesses and also to surfaces of the primary particles in the recesses other than the interfaces.

### [Experiment]

The batteries were each charged at a constant current of 800 mA to a battery voltage of 4.50 V, and further charged at a constant voltage of 4.5 V until the current value reached 40 mA. The batteries were stored in a thermostatic chamber at 80° C. for one day, and the thickness of each battery was measured. The results are described in Table 1.

TABLE 1

| | | | | Swelling |
|---|---|---|---|---|
| | Lithium transition | Method of mixing | Attachment of | of battery |
| Battery | metal oxide | of compounds | compound | (mm) |
| A1 | LiCo_{0.84}Ni_{0.1}Mn_{0.05}Al_{0.01}O₂ | B₂O₃ was wet | Compound | 5.54 |
| | | mixed with oxide | containing Li, B | |
| | | and mixture was | and O was | |
| | | heat treated. | aggregated in | |
| | | | recesses. | |
| A2 | LiCo_{0.84}Ni_{0.1}Mn_{0.05}Al_{0.01}O₂ | BLiO₂•2H₂O was | Compound | 4.68 |
| | | wet mixed with | containing Li, B | |
| | | oxide and mixture | and O was | |
| | | was heat treated. | aggregated in | |
| | | | recesses. | |
| A3 | LiCo_{0.84}Ni_{0.1}Mn_{0.05}Al_{0.01}O₂ | — | — | 6.21 |
| A4 | LiCo_{0.84}Ni_{0.1}Mn_{0.05}Al_{0.01}O₂ | B₂O₃ was added | B₂O₃ was | 6.8 |
| | | to positive | dispersed. | |
| | | electrode slurry. | | |
| A5 | LiCo_{0.84}Ni_{0.1}Mn_{0.05}Al_{0.01}O₂ | B₂O₃ was dry | Compound | 9.43 |
| | | mixed with oxide | containing Li, B | |
| | | and mixture was | and O was | |
| | | heat treated. | dispersed. | |
| A6 | LiCoO₂ | B₂O₃ was wet | Compound | 10.9 |
| | | mixed with oxide | containing Li, B | |
| | | and mixture was | and O was | |
| | | heat treated. | aggregated in | |
| | | | recesses. | |

The battery A1 and the battery A2 had small swelling after being stored at a high temperature in a highly charged state as compared to the battery A3, probably for the reasons described below. In the positive electrode active materials used in the battery A1 and the battery A2, primary particles which were adjacent to one another had formed recesses on the surface of the secondary particles of the lithium transition metal oxide, and the compound containing boron and oxygen had been attached to such recesses formed between the adjacent primary particles on the surface of the secondary particles of the lithium transition metal oxide. As a result, the electrolytic solution that had decreased its viscosity at the high temperature was prevented from an entry into the inside through the interfaces between the primary particles of the lithium transition metal oxide, and consequently the decomposition reaction of the electrolytic solution itself was prevented from occurring. In the battery A1 and the battery A2, the compound containing boron and oxygen further contained lithium. That is, in the battery A1 and the battery A2, the compound attached to the lithium transition metal oxide contained lithium, boron and oxygen. In this case, the reaction, if any, by which the electrolytic solution is decomposed will be selectively a film-forming reaction which gives a film having excellent lithium ion conductivity, and any gas-producing reaction will be suppressed more effectively.

In the positive electrode active material used in the battery A4, the compound containing boron and oxygen was dispersed over the surface of the lithium transition metal oxide but was probably absent in the recesses. As a result, the electrolytic solution that had decreased its viscosity at the high temperature probably found its way into the inside of the lithium transition metal oxide, and consequently the decomposition reaction of the electrolytic solution and the consequent generation of gas could not be prevented from occurring.

In the positive electrode active material used in the battery A5, the compound containing boron and oxygen was present on the surface of the secondary particles of the lithium transition metal oxide. However, the compound containing boron and oxygen was absent in the recesses. As a result, similarly to the battery A4, the battery A5 probably allowed an entry of the electrolytic solution into the inside of the lithium transition metal oxide and thus facilitated the occurrence of the decomposition reaction of the electrolytic solution, failing to prevent the occurrence of a gas-producing reaction. The battery A5 had been swollen by a greater degree than the battery A4, presumably partly because in the battery A5, the positive electrode active material and boron oxide (B₂O₃) were dry mixed and the mixture was heat treated at a higher temperature.

The battery A6 had larger swelling than the battery A1. In the battery A6 which used lithium cobaltate as the lithium transition metal oxide, the crystal structure underwent a phase transition during the charging to a high battery voltage of 4.50 V (about 4.6 V versus lithium). The phase transition resulted in an increase in the reactivity of the surface of lithium cobaltate with respect to the electrolytic solution. This is probably the reason why a very large amount of gas was produced during the storage of the highly charged battery at high temperature. Probably because of this, in the battery A6, the production of gas as a whole could not be controlled even by the attachment of the compound containing boron and oxygen to the recesses on the surface of the secondary particles of lithium cobaltate. On the other hand, the battery A1 involved LiCo_{0.84}Ni_{0.10}Mn_{0.05}Al_{0.01}O₂ as the lithium transition metal oxide. The crystal structure of this lithium transition metal oxide was resistant to phase transition even when the battery was charged to a high voltage of 4.50 V. Consequently, the surface of the lithium transition metal oxide remained less reactive with respect to the electrolytic solution, and this is probably the reason for the small generation of gas during the storage of the highly charged battery at high temperature.

While the above experiment involved LiCo_{0.04}Ni_{0.10}Mn_{0.05}Al_{0.01}O₂ as the lithium transition metal oxide, the effects described hereinabove will be obtained as long as the lithium transition metal oxide used contains lithium, cobalt, nickel, manganese and aluminum, and the proportion of cobalt in the lithium transition metal oxide is not less than 80 mol % relative to the total molar amount of the metal elements except lithium.

While the battery voltage used in the above experiment was 4.5 V (about 4.6 V versus lithium), results similar to those described above will be obtained as long as the voltage is in the range of 4.53 V to 4.75 versus lithium.

### REFERENCE SIGNS LIST

10 NONAQUEOUS ELECTROLYTE SECONDARY BATTERY
11 LAMINATE EXTERIOR CASE
12 WOUND ELECTRODE ASSEMBLY
13 POSITIVE ELECTRODE
14 NEGATIVE ELECTRODE
14a NEGATIVE ELECTRODE CURRENT COLLECTOR
14b NEGATIVE ELECTRODE MIXTURE LAYER
14c NEGATIVE ELECTRODE ACTIVE MATERIAL
14d NEGATIVE ELECTRODE ACTIVE MATERIAL
15 SEPARATOR
16 POSITIVE ELECTRODE CURRENT COLLECTOR TAB
17 NEGATIVE ELECTRODE CURRENT COLLECTOR TAB
18 HEAT-SEALED PORTION
19 EXTENDED SPACE

1. A nonaqueous electrolyte secondary battery comprising a positive electrode containing a positive electrode active material capable of storing and releasing lithium ions, a negative electrode containing a negative electrode active material capable of storing and releasing lithium ions, and a nonaqueous electrolyte, wherein
the positive electrode active material includes secondary particles formed by the aggregation of primary particles including a lithium transition metal oxide containing lithium, cobalt, nickel, manganese and aluminum,
the secondary particles have on the surface thereof a recess formed between the primary particles adjacent to one another and a compound containing boron and oxygen is attached to the recess, and
the proportion of cobalt in the lithium transition metal oxide is not less than 80 mol % relative to the total molar amount of the metal elements except lithium.

2. The nonaqueous electrolyte secondary battery according to claim 1, wherein the compound containing boron and oxygen is attached to an interface between the primary particles that is found in the recess.

3. The nonaqueous electrolyte secondary battery according to claim 1, wherein the compound containing boron and oxygen is a compound containing lithium, boron and oxygen.

4. The nonaqueous electrolyte secondary battery according to claim 1, wherein the lithium transition metal oxide is represented by the compositional formula LiCoₐNi_{b}Mn_{c}Al_{d}MₑO₂ (0.8≦a≦0.95, 0.03≦b≦0.25, 0.02≦c≦0.07, 0.005≦d≦0.02, 0≦e≦0.02, and M is at least one selected from Si, Ti, Ga, Ge, Ru, Pb and Sn).

5. The nonaqueous electrolyte secondary battery according to claim 1, wherein the nonaqueous electrolyte includes a fluorinated solvent.

6. The nonaqueous electrolyte secondary battery according to claim 1, which is charged to a positive electrode potential of not less than 4.53 V versus lithium.
